(19) United States
(12) Patent Application Publication
(10) Pub. No.: US 2022/0101248 A1
(43) Pub. Date: Mar. 31, 2022

(54) ANALYZING RECEIVED DATA AND CALCULATING RISK OF DAMAGE TO A PACKAGE FOR DELIVERY

(71) Applicant: International Business Machines Corporation, Armonk, NY (US)

(72) Inventors: Robert Huntington Grant, Marietta, GA (US); Jacob Thomas Covell, New York, NY (US); Clarissa Ho, New York, NY (US); Alvin Zhang, Somerville, MA (US)

(21) Appl. No.: 16/948,761

(22) Filed: Sep. 30, 2020

(51) Int. Cl. G06Q 10/08; G06Q 30/02; G06F 40/40; B64C 39/02; G06Q 50/28

(52) U.S. Cl. CPC G06Q 10/0832; G06Q 10/08355; G06Q 30/0282; B64C 2201/128; B64C 39/024; G06Q 50/28; G06F 40/40

(57) ABSTRACT

Identifying and reducing package delivery risks can include receiving, at a computer, package delivery data for a package to be delivered. Package delivery factors can be determined which include package fragility. Product information and product reviews can be analyzed based on the factors, and the analyzing can include using natural language processing to evaluate the product information and product reviews to identify language related to the factors. The factors can be weighted based on the analysis of the product information and the product reviews based on a probability of risk of damage to the package. A package risk score is calculated based on the analysis and the weighting. A best delivery practice for the package is generated based on the package risk score, and the package risk score and best delivery practice is communicated to a device of a delivery person.

### BACKGROUND

The present disclosure relates to analyzing data, received by a computer, to calculate risk of damage to an item in a package being delivered or packaged for delivery, and more particularly, to implement risk reduction for package delivery.

E-commerce is a large and growing market, which is accountable for a sizable number of retail sales, and is projected to continue growing. Key players in the e-commerce market wield enormous influence and power, and ship tremendous amounts of packages a year, by one estimate, accounting for almost half of total retail e-commerce sales. These figures may continue to grow in the future as changes in consumer behavior perpetuate the e-commerce trend.

Shifting trends in retail, such as e-commerce, have also resulted in problems. E-commerce retailers who process and ship packages daily can struggle to find a balance between fast ship times and high quality of shipments in the quest to remain profitable and maintain competitive customer satisfaction rates. Packages can be tossed and improperly handled due to the sheer volume of packages and the pressure to quickly deliver. Many E-commerce packages can arrive damaged, especially during high volume periods of time, for example, holiday seasons and sale times. Mishandling of packages can lead to damages that are costly to the retailer, as customers are likely to request for a replacement for the defective item, and inconvenient for shoppers, as a buyer will have to return or request replacement/refund, and also the buyer may incur costs, such as restocking or shipping.

### SUMMARY

The present disclosure recognizes the shortcomings and problems associated with current techniques for recuing package mishandling and reducing risk of package damage.

To improve current processes, a delivery optimization tool is needed to identify fragile packages that are sensitive to mishandling, and mark those that should be handled with care to avoid unnecessary damages and additional costs.

The present invention helps package handlers identify packages with high risk scores or high fragility scores (i.e., higher sensitivity to damages/fragility) and process them in the appropriate manner, thereby benefiting both the consumer, who is less likely to receive a damaged package, and the supplier, who avoids additional costs of returning and exchanging damaged packages. Thus, the present invention can reduce the frequency of damaged packages while enhancing delivery times through a dynamic real-time analyzer of package contents, product data and product reviews. In one embodiment, a method and system can include a learning-based algorithm to scan and sort product returns and reviews in addition to live sensory data from environmental factors to dynamically compute a package delivery risk level.

In an aspect according to the present invention, a computer-implemented method for identifying and communicating package delivery risks to reduce package damage risk during delivery. The method includes receiving, at a computer, package delivery data for a package to be delivered. The method includes determining, using the computer, package delivery factors, the factors including package fragility. Using the computer, product information and product reviews based on the factors are analyzed. The analysis includes using natural language processing to evaluate the product information and product reviews to identify language related to the factors. The method includes determining a probability of risk of damage to the package based on the factors and the analysis of the product information and the product review, and weighting the factors in response to the determining the probability of risk of damage to the package. The method include calculating a package risk score based on the weighting of the factors and the determining of the probability of risk of damage, and generating a best delivery practice for the package based on the package risk score. And, the method includes communicating the package risk score and best delivery practice to a device of a delivery person.

In a related aspect of the method, the package delivery factors include sensitivity of the package to a collision.

In another related aspect of the method, the package delivery factors include sensitivity to a stacking weight.

In another related aspect of the method, the factors include package content sensitivity.

In another related aspect of the method, the package content sensitivity includes determining factors for environmental conditions.

In another related aspect of the method, the environment conditions include heat, and cold.

In another related aspect of the method, the package is delivered by a delivery truck and delivery person.

In another related aspect of the method, the package is delivered by a drone operated by a drone operator or a drone control system.

In another related aspect of the method, the communicating of the package risk score and best delivery practice is to a device of a drone operator, or a drone control system.

In another aspect according to the present invention, a system uses a computer for identifying and communicating package delivery risks to reduce package damage risk during delivery. The computer system includes; a computer processor, a computer-readable storage medium, and program instructions stored on the computer-readable storage medium being executable by the processor, to cause the computer system to perform the following functions to; receive, at a computer, package delivery data for a package to be delivered; determine, using the computer, package delivery factors, the factors including package fragility; analyze, using the computer, product information and product reviews based on the factors, the analyzing including using natural language processing to evaluate the product information and product reviews to identify language related to the factors; determine a probability of risk of damage to the package based on the factors and the analysis of the product information and the product review; weight the factors in response to the determining the probability of risk of damage to the package; calculate a package risk score based on the weighting of the factors and the determining of the probability of risk of damage; generate a best delivery practice for the package based on the package risk score; and communicate the package risk score and best delivery practice to a device of a delivery person.

In a related aspect of the system, the package delivery factors can include sensitivity of the package to a collision.

In a related aspect of the system, the package delivery factors includes sensitivity to a stacking weight.

In a related aspect of the system, the factors can include package content sensitivity.

In a related aspect of the system, the package content sensitivity can include determining factors for environmental conditions.

In a related aspect of the system, the environment conditions can include heat, and cold.

In a related aspect of the system, the package can be delivered by a delivery truck and delivery person.

In a related aspect of the system, the package can be delivered by a drone operated by a drone operator or a drone control system.

In a related aspect of the system, the communicating of the package risk score and best delivery practice can be a device of a drone operator, or a drone control system.

In another aspect according to the present invention, a computer program product for identifying and communicating package delivery risks to reduce package damage risk during delivery includes a computer readable storage medium having program instructions embodied therewith. The program instructions are executable by a computer to cause the computer to perform functions, by the computer, comprising the functions to: receive, at a computer, package delivery data for a package to be delivered; determine, using the computer, package delivery factors, the factors including package fragility; analyze, using the computer, product information and product reviews based on the factors, the analyzing including using natural language processing to evaluate the product information and product reviews to identify language related to the factors; determine a probability of risk of damage to the package based on the factors and the analysis of the product information and the product review; weight the factors in response to the determining the probability of risk of damage to the package; calculate a package risk score based on the weighting of the factors and the determining of the probability of risk of damage; generate a best delivery practice for the package based on the package risk score; and communicate the package risk score and best delivery practice to a device of a delivery person.

In a related aspect of the computer program product, the package delivery factors can include sensitivity of the package to a collision.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram illustrating an overview of a system, system features or components, and methodology for identifying and communicating package delivery risks to reduce package damage risk during delivery, according to an embodiment of the present disclosure.

FIG. 2 is a flow chart illustrating a method, implemented using the system shown in FIG. 1, for identifying and communicating package delivery risks to reduce package damage risk during delivery, according to an embodiment of the present disclosure.

FIG. 3 is a functional schematic block diagram showing a series of operations and functional methodologies, for instructional purposes illustrating functional features of the present disclosure associated with the embodiments shown in the FIGS., for identifying and communicating package delivery risks to reduce package damage risk during delivery.

FIG. 4 is a flow chart illustrating another method, which can be implemented, at least in part, using the system shown in FIG. 1, for identifying and communicating package delivery risks to reduce package damage risk during delivery, according to an embodiment of the present disclosure.

FIG. 5 is a schematic block diagram depicting a computer system according to an embodiment of the disclosure which may be incorporated, all or in part, in one or more computers or devices shown in FIG. 1, and cooperates with the systems and methods shown in the FIGS.

FIG. 6 is a schematic block diagram of a system depicting system components interconnected using a bus. The components for use, in all or in part, with the embodiments of the present disclosure, in accordance with one or more embodiments of the present disclosure.

FIG. 7 is a block diagram depicting a cloud computing environment according to an embodiment of the present invention.

FIG. 8 is a block diagram depicting abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### Embodiments and Examples

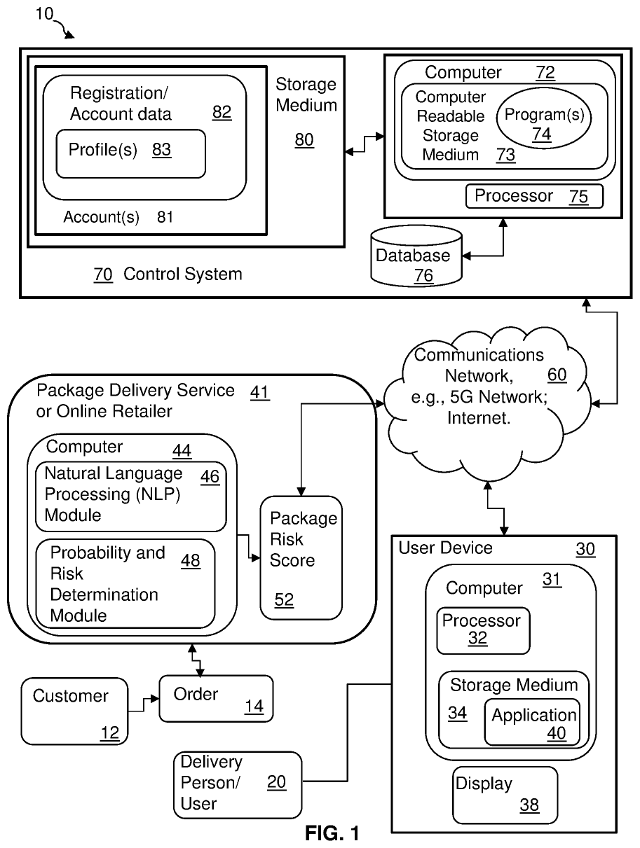

Referring to FIGS. 1 and 2, and FIG. 3, a computer-implemented method 100 for identifying and communicating package delivery risks to reduce package damage risk during delivery, according to an embodiment of the present disclosure. The method 100 includes a series of operational blocks for implementing an embodiment according to the present disclosure which includes receiving, at a computer 44, package delivery data for a package 312 to be delivered, as in block 104. The package delivery data is derived from the item or product 304 which is packaged in the package 308. The computer 44 is part of a package delivery service or an online retailer 40. The package delivery service 40 can receive an order 14 from or initiated from a customer 12. In one example, a business can place orders as well as a customer or a purchasing agent for a business.

The method includes determining, using the computer 44, package delivery factors 316, the factors including package fragility 320, as in block 108. In one example, package fragility can include the likelihood of an item breaking, such as a glass item, or ceramic, etc. which can break from rough handling, or an impact. In another example, other factors can include the type of item, such as finer elements that can damage easily or have a high likelihood of damage if not handled with care. In another example, a package delivery factor can include sensitivity to heat or cold, for example, food items or edible items.

The method includes analyzing, using the computer, product information and product reviews 324 based on the factors 316, the analyzing including using natural language processing 46 to evaluate the product information and product reviews 324 to identify language 328 related to the factors, 316 as in block 112. For example, the method can access product information which is public, and likewise access product reviews which are publicly accessible. Further, the method can evaluate the product information and product reviews by analyzing the product information and product reviews using natural language processing (NLP), in which, the text of the product information and product reviews can be analyzed, for example, for key words, such as fragile, breakable, damaged. In another example the analysis using NLP can include identifying subject matter, topics, issues, or trends, which may help in identifying item or product handing information. The identification and evaluation of the analysis can be used to identify language related to the factors, for example.

In one example, the method can set a threshold for the analysis, as in block 116. For example, the method can set a threshold for receiving information such as the product information and product reviews. In one example, the method can set a threshold for an amount of product information and/or product reviews, or that the analysis should include product information and product reviews. In another example, the method can include setting a threshold for a number of product reviews, or, in another example, a date rage of product reviews, or in another example, reviews from a specific source, or from multiple sources.

When the analysis threshold 116 is not met, the method can return to block 112 to analyze the information again or analyze additional reviews. When the analysis threshold 116 is met, the method can continue to block 120.

The method includes determining a probability of risk of damage 332 to the package 308 based on the factors 316 and the analysis of the product information and the product review 324, as in block 120. For example, the method can assess a high risk or probability of damage to a package if the package is not handled with care, when the analysis determines a fragile package with customer comments about the fragileness of the package. Similarly, for example, medium and low risk assessments can be concluded for product information and customers reviews congruent with lower risk scores.

The method includes weighting 336 the factors in response to the determining the probability of risk of damage 332 to the package, as in block 124. For example, the method can weight a factor heavily or weight it high in response to a high likelihood or probability of damage. In another example, the method can weigh the factor of fragility as high, for example, on a scale of 1-10, a 9 or 10, in response to a package having a high likelihood or probability of damage due to being fragile or based on a scale of fragility.

The method includes calculating a package risk score 340 based on the weighting 336 of the factors and the determining of the probability of risk of damage, as in block 128. For example, a package with a high weighting can coincide with high package risk score.

The method includes generating a best delivery practice 344 for the package 308 based on the package risk score 340, as in block 132. For example, a best delivery practice can include handling with care, do not throw or toss, do not stack, for instance, in a delivery truck or a warehouse, etc. In another example, a package risk score which is high, can result in more restrictions or care in handling the package. Likewise, a low package risk score can result in less restrictions or care in handling the package.

The method includes communicating the package risk score and best delivery practice to a device of a delivery person, as in block 136. For example, the communication 348 can include a text message to a user device, that is, a delivery person's smart device, or one assigned by an employer. In another example, a communication can be a voice message, or a text being audibly transcribed. In another example, a communication can include displaying the communication in text, in one example, with the risk score, on a display 38 of a user device 30. The user device 30 includes a computer 31 having a processor 32 and a storage medium 34 where an application 40, can be stored. The application can embody the features of the method of the present disclosure as instructions.

In one example, the package delivery factors can include sensitivity of the package to a collision. For instance, whether a package can be gently tossed onto a surface, or have other package sacked on it. In another example, the package delivery factors can include sensitivity to a stacking weight, such as, having other packages stacked on it, for instance, in a warehouse or a delivery truck.

In another example, the factors can include package content sensitivity, for example, the package content sensitivity can include determining factors for environmental conditions. In another example, environment conditions include heat, and cold.

In one example, the package can be delivered by a delivery truck and delivery person. In another example the package can be delivered by a drone operated by a drone operator or a drone control system. In one example, the control system 70 can be an embodiment of a drone control system.

In another example, the communicating of the package risk score and best delivery practice can be to a device of a drone operator, or a drone control system. In one example, the communication can use the Internet, or in another example, can use a cellular network. In one example, a device can be a mobile device or a smart device.

### Other Embodiments and Examples

The user can connect to the package delivery service 40 using a device 30. The device can include a computer 31 having a processor 32 and computer readable storage medium 34, and a display or monitor 38. An application 40 embodying the method of the present disclosure can be stored on the computer readable storage medium 34. The device 30 further including the processor 32 for executing the application/software. The device 30 can communicate with a communications network 60, e.g., the Internet.

It is understood that the user device 30 is representative of similar devices which can be for other user, as representative of such devices, which can include, mobile devices, smart devices, laptop computers etc.

In another example and embodiment, profiles can be saved for users/participants. Such profiles can supply data regarding the user and history of deliveries for analysis. When a profile is not found at block 112, the method creates a profile at block 116.

In one example, the system of the present disclosure can include a control system 70 communicating with the user device 30 via a communications network 60. The control system can incorporate all or part of an application or software for implementing the method of the present disclosure. The control system can include a computer readable storage medium 80 where account data and/or registration data 82 can be stored. User profiles 83 can be part of the account data and stored on the storage medium 80. The control system can include a computer 72 having computer readable storage medium 73 and software programs 74 stored therein. A process or 75 can be used to execute or implement the instructions of the software program. The control system can also include a database 76.

In one example, a user can register or create an account using the control system 70 which can include one or more profiles 83 as part of registration and/or account data 82. The registration can include profiles for each user having personalized data. For example, users can register using a website via their computer and GUI (Graphical User Interface) interface. The registration or account data 82 can include profiles 83 for an account 81 for each user. Such accounts can be stored on the control system 70, which can also use the database 76 for data storage.

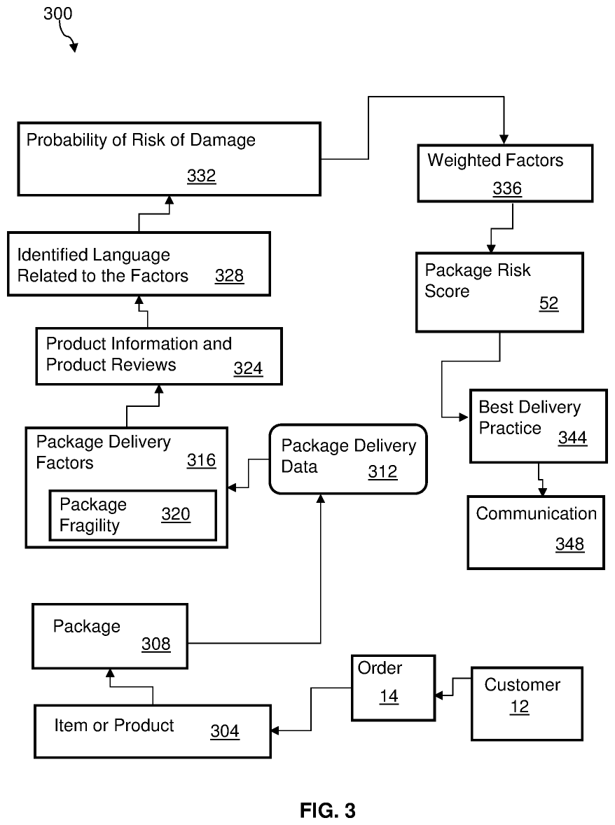

Additionally, the method and system is discussed with reference to FIG. 3, which is a functional system 300 which includes components and operations for embodiments according to the present disclosure, and is used herein for reference when describing the methods and systems of the present disclosure. Additionally, the functional system 300, according to an embodiment of the present disclosure, depicts functional operation indicative of the embodiments discussed herein.

### Other Embodiments and Examples

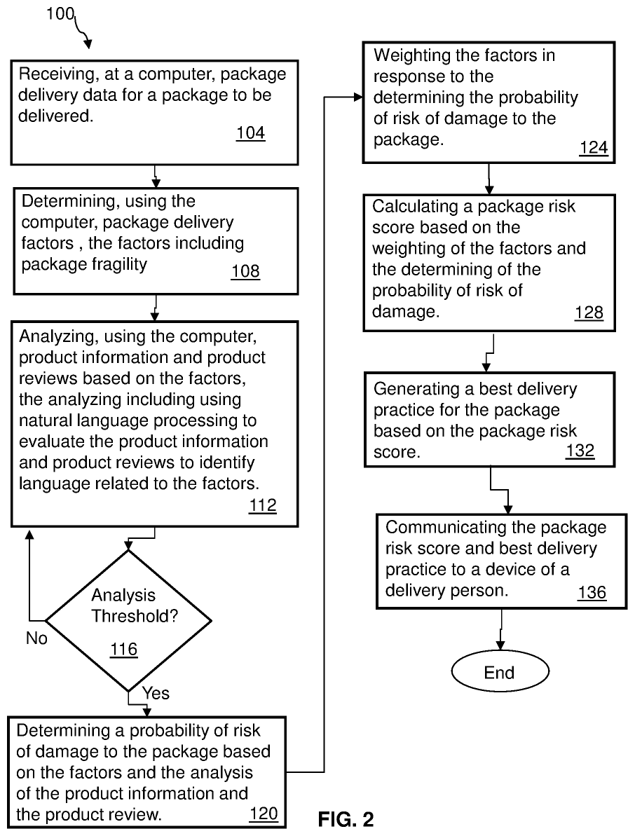

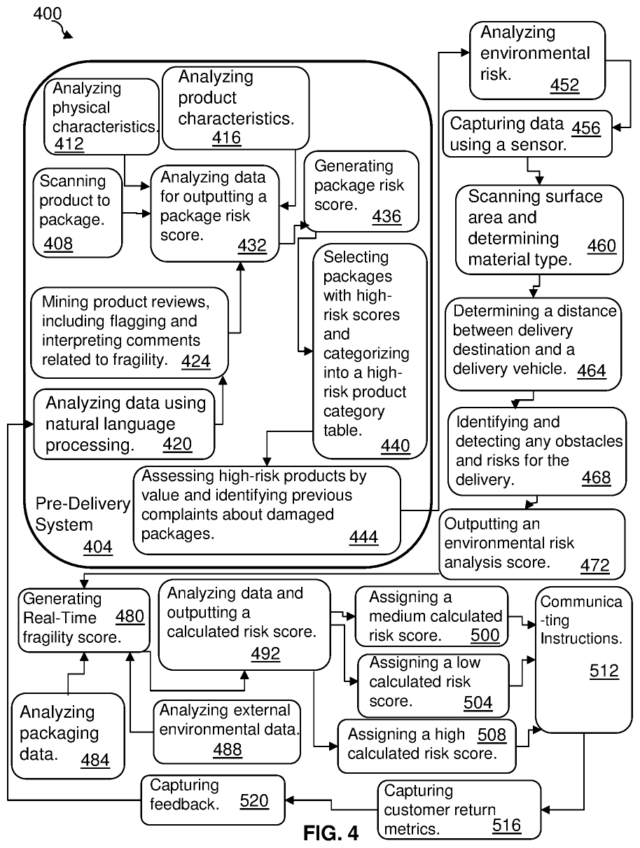

Operational blocks of the method 400 shown in FIG. 4 may be similar to operational blocks shown in FIGS. 1 and 2. The method shown in FIG. 4 is intended as another example embodiment which can include aspects/operations shown and discussed previously in the present disclosure.

The present disclosure includes reducing the frequency of damaged packages while enhancing or increasing delivery times through a dynamic real-time analyzer of package contents, product data, product reviews, and environmental/surrounding data. The method and system of the present disclosure can utilize a learning-based algorithm to scan and sort product returns and reviews in addition to live sensory data from the environmental factors to dynamically compute a package risk score or a package delivery risk level. The present disclosure is directed to utilizing previous customer reviews, customer return data, a learning-based system in addition to the live data received from sensors to dynamically determine the optimal mode of package delivery.

Embodiments according to the present disclosure can derive a package contents risk score based on product reviews and return data, product category, product value, dimensions, material, and weight. An embodiment can be installed on a package scanning device. In one example, the method and system can be integrated with an E-commerce backend inventory database to source product-level data/specifications. In another example, a method and system can analyze product reviews and return data. Specific fragility issues can be detected based on customer complaints, such as cracks, broken subcomponents, etc. Product review and return data metrics can be analyzed. Ina another example, product(s) can be compared in a package against a pre-defined High-Risk Product category table to identify potentially fragile packages. In another example, camera data can be paired with GPS (Global Positioning System) data to recognize when a delivery vehicle is approaching the final destination for a specific package.

In another example, camera data can be used to analyze the target surface area and obstacles/surface risks, for example, grass vs. concrete, and determine if there are obstacles such as trees. In another example, aggregate data from vehicle-mounted sensors can be used to derive a real-time environmental risk analysis based on: a target surface area; distance between target surface area and the vehicle; obstacles/surface risks; and weather/forecasted weather. In another example, data can be aggregated, and a real-time fragility score can be calculated by combining the: package contents risk score; environmental risk; accelerometer data, etc.

An optimal delivery method (light toss vs. hand deliver/etc., or drone delivery height) can be provided using a display output to the delivery driver (or drone operator) based on a real-time fragility score. Specific suggestions can be displayed to a delivery driver based on external factors, such as “please shield from [predicted] rain”. A drone delivery embodiment (e.g., factoring in the optimal height of drop-off). In one embodiment, customer reviews/return metric can be captured as feedback into the real-time fragility score learning engine, to improve future accuracy.

Thus, the present disclosure can leverage the abundance of customer data related to product reviews and returns on e-commerce platforms to improve delivery efficiency. In addition, a package contents risk score of a certain package can be impacted/calculated, based on a classification of product reviews/return data. Based on customer's reviews/return metrics, package delivery can be determined, such as an optimal height to drop a package filled with a variety of contents from a drone (that is, in order to balance both speed and quality of delivery).

A Real-Time Fragility score could be calculated based on the package contents risk, and environmental risk, and other real-time external factors. In addition, because this would be a supervised learning model, as feedback was provided, the weights/thresholds/criteria could be tweaked accordingly to provide more accurate real-time fragility scores, which might lead towards faster deliveries and/or less cost associated with damaged orders.

Referring to FIG. 4, a method 400 and system according to an embodiment of the present disclosure includes functions of a pre-delivery system 404 which are input for analyzing data for outputting a calculated risk score, as in block 432. The inputs can include, include scanning a product to package, as in block 408. Such scanning can include using a bar code. The method includes analyzing physical characteristics, as in block 412, for example, a weight or material of a product. Further, the method includes analyzing product characteristics, as in block 416, for example, a category or type of product, or a value of a product. Additionally, the method includes analyzing data using natural language processing, as in block 420, and mining product reviews, including flagging and interpreting comments related to fragility, as in block 424, using the natural language processing. For example, the method can analyze product reviews left by customer who purchased the product.

The method includes generating a package risk score, as in block 436, as an output of block 434. The method includes selecting packages with high-risk scores and categorizing the packages into a high-risk product category table, as in block 440. The method includes assessing high-risk products by value and identifying previous complaints about damaged package, as in block 444.

The method 400 continues by analyzing environmental risk, at block 452, using captured data using one or more sensors, as in block 456, such as cameras, GPS data, and/or other sensors. The method includes scanning a surface area and determining material type, as in block 460. The material type can include concrete, glass, wood, etc. The method includes determining a distance between delivery destination and a delivery vehicle, as in block 464. Further, the method includes identifying and detecting obstacles and risks for the delivery, as in block 468. For example, an obstacle can include steps, terrain, etc. The method includes outputting an environmental risk analysis score, as in block 472.

Additionally, the method includes generating a real-time fragility score, as in block 480. The method includes analyzing packaging data, as in block 484. For example, packaging data can include a type of material, a size, etc. The method includes analyzing external environmental data, as in block 488. For example, external environmental data can include a time, weather, wind speed, or accelerometer data, etc. The generation of the real-time fragility score receives input from the packaging data analysis, of block 484, and the analysis of external environmental data, of block 488. The method includes analyzing a data and outputting a calculated risk score, as in block 492. For example, the risk score can include predetermined classification, such as, low risk, medium risk, or high risk. In one example, the method includes assigning a low calculated risk score 500, or a medium calculated risk score 504, or a high calculated risk score 508. The method includes communicating instructions, including the risk score (or real-time fragility risk score) to a delivery person, as in block 512, by way of a mobile device to instruct the delivery person in handling the package.

The method and system can include capturing customer return metrics as in block 516 including capturing feedback from customers as in block 520. The method can feed the captured customer return metrics and feedback into the analysis of data of block 420. Thus, providing a learning mechanism for the method and system. For example, the feedback 520 and customer return metrics 516 can be used as input for the analysis of data using natural language processing, thereby providing a learning model/mechanism. As a result of the learning model/mechanism, a weighted score can be assigned, such as weights/thresholds/criteria, and can be tweaked accordingly to provide more accurate real-time fragility scores. Such real-time feedback can result in faster delivery times and reduced damage to packages.

Referring to the method 400 and pre-delivery system 404, in one example, a delivery person could be delivering packages for an e-commerce company that sells a variety of goods, with the contents of each package bearing no relation to one another except for their delivery route to the final destination. The method can include utilizing external data that is both static: package data from the inventory database (value, weight, etc.)(for example, as in blocks 412 and 416) and real-time: accelerometer data, time and weather data (for example, as in block 488). Package risk scores can be calculated, as in blocks 432 and 436, for each of a plurality of packages based on inventory data. The package risk score can be calculated based on inventory data and can utilize a natural language understanding (NLU) module of a computer to analyze product reviews and flags comments related to fragility to form a complete analysis of the product.

Continuing with the above example, as a result of a fragile package, such as glassware, the package can be assigned a high-risk score, as in block 508. In addition, when a package delivery person arrives as a destination for delivery, the method and system can perform an environmental risk analysis, for instance, using cameras, sensors and/or GPS to account for the type of surface, and to detect the distance between delivery destination and delivery vehicle, as well as any obstacles in between, as in blocks 452, 456, 460, 464, 468. A real-time fragility score, as in block 480, can be computed based on the package risk score, and environmental risk analysis, and other varying factors, such as, package size, packaging material, accelerometer data, time of day, weather, etc. A score conversion can be performed, and based on predetermined thresholds, scores can be placed into categories, for example, one of the three categories: low, normal, extreme, or low, medium and high risk.

As a result of the real-time fragility score being communicated to a package delivery person, for example, sending to a mobile device of the person, the deliverer can be made aware of package contents and/or the surrounding external factors resulting in a higher sensitivity to damage. The deliverer can then adjust their delivery method and/or care when delivering the package, for example, not tossing the package or placing roughly on a surface. The deliverer can determine an appropriate delivery method for the specific package, and/or the method and system can generate a suggested delivery method appropriate to the fragility score.

In one example, the natural language understanding module can review product reviews and product returns to analyze for determining a package risk score. Questions for the analysis can include, for example, how often does an item get returned due to a reason of being a damaged package. In another example, the method and system can search for customer reviews which include trigger words, such as, fragile, broken, cracked, etc.). The method and system can also determine how many products have been returned due to delivery issues, such as, arrived broken, etc.

Thus, the present disclosure can utilize a natural language understanding (NLU) module to mine and analyze product reviews. Further, the present disclosure can factor in product reviews and returns in the calculation of a delivery sensitivity score and risk optimization. And, further, a dynamic analysis can be used to take into account external factors and real-time data that change based on the situation.

### Further Embodiments and Examples

Account data, for instance, including profile data related to a user, and any data, personal or otherwise, can be collected and stored, for example, in the control system 70. It is understood that such data collection is done with the knowledge and consent of a user, and stored to preserve privacy, which is discussed in more detail below. Such data can include personal data, and data regarding personal items.

In one example a user can register 82 have an account 81 with a user profile 83 on a control system 70, which is discussed in more detail below. For example, data can be collected using techniques as discussed above, for example, using cameras, and data can be uploaded to a user profile by the user.

### More Examples and Embodiments

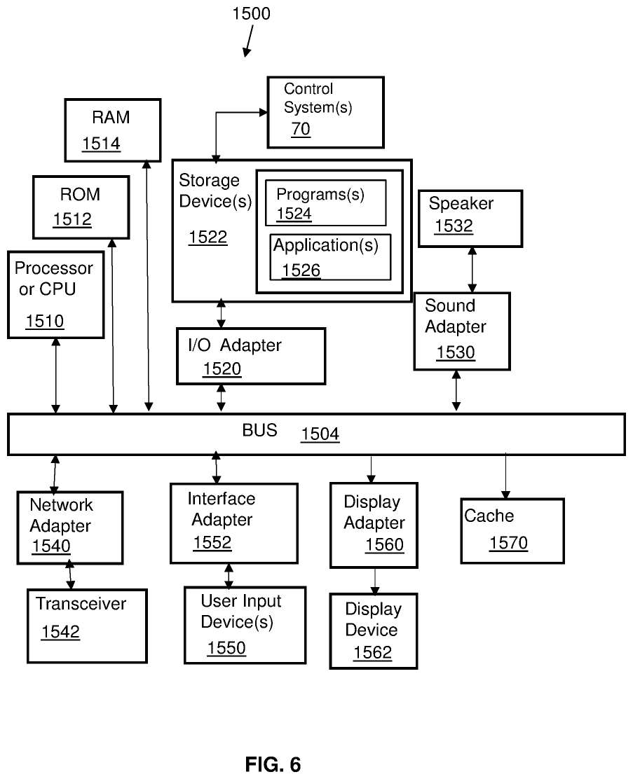

In the embodiment of the present disclosure shown in FIGS. 1 and 2, a computer can be part of a remote computer or a remote server, for example, remote server 1100 (FIG. 6). In another example, the computer 72 can be part of a control system 70 and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the mobile device can include a computer 30 having a processor 32 and a storage medium 34 which stores an application 40. The application can incorporate program instructions for executing the features of the present disclosure using the processor 32. In another example, the mobile device application or computer software can have program instructions executable for a front end of a software application incorporating the features of the method of the present disclosure in program instructions, while a back end program or programs 74, of the software application, stored on the computer 72 of the control system 70 communicates with the mobile device computer and executes other features of the method. The control system 70 and the mobile device or computer 30 can communicate using a communications network 60, for example, the Internet.

Thereby, the method 100 according to an embodiment of the present disclosure, can be incorporated in one or more computer programs or an application 40 stored on an electronic storage medium 34, and executable by the processor 32, as part of the computer on the mobile device. For example, a mobile device can communicate with the control system 70, and in another example, a device such as a video feed device can communicate directly with the control system 70. Other users (not shown) may have similar mobile devices which communicate with the control system similarly. The application can be stored, all or in part, on a computer or a computer in a mobile device and at a control system communicating with the mobile device, for example, using the communications network 60, such as the Internet. It is envisioned that the application can access all or part of program instructions to implement the method of the present disclosure. The program or application can communicate with a remote computer system via a communications network 60 (e.g., the Internet) and access data, and cooperate with program(s) stored on the remote computer system. Such interactions and mechanisms are described in further detail herein and referred to regarding components of a computer system, such as computer readable storage media, which are shown in one embodiment in FIG. 6 and described in more detail in regards thereto referring to one or more computer systems 1010.

Thus, in one example, a control system 70 is in communication with the computer 30, and the computer can include the application or software 40. The computer 30, or a computer in a mobile device (not shown) communicates with the control system 70 using the communications network 60.

In another example, the control system 70 can have a front-end computer belonging to one or more users, and a back-end computer embodied as the control system.

Also, referring to FIG. 1, a device can include a computer 30, computer readable storage medium 34, and operating systems, and/or programs, and/or a software application 40, which can include program instructions executable using a processor 32. These features are shown herein in FIG. 1, and also in an embodiment of a computer system shown in FIG. 6 referring to one or more computer systems 1010, which may include one or more generic computer components.

The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

Specifically, regarding the control system 70, a device(s) 30, or in one example the devices which can belong to one or more users, can be in communication with the control system 70 via the communications network 60. In the embodiment of the control system shown in FIG. 1, the control system 70 includes a computer 72 having a database 76 and one or more programs 74 stored on a computer readable storage medium 73. In the embodiment of the disclosure shown in FIG. 1, the device 30 communicate with the control system 70 and the one or more programs 74 stored on a computer readable storage medium 73. The control system includes the computer 72 having a processor 75, which also has access to the database 76.

The control system 70 can include a storage medium 80 for maintaining a registration 82 of users and their devices for analysis of the audio input. Such registration can include user profiles 83, which can include user data supplied by the users in reference to registering and setting-up an account. In an embodiment, the method and system which incorporates the present disclosure includes the control system (generally referred to as the back-end) in combination and cooperation with a front end of the method and system, which can be the application 40. In one example, the application 40 is stored on a device, for example, a computer on location 30, and can access data and additional programs at a back end of the application, e.g., control system 70.

The control system can also be part of a software application implementation, and/or represent a software application having a front-end user part and a back-end part providing functionality. In an embodiment, the method and system which incorporates the present disclosure includes the control system (which can be generally referred to as the back-end of the software application which incorporates a part of the method and system of an embodiment of the present application) in combination and cooperation with a front end of the software application incorporating another part of the method and system of the present application at the device, as in the example shown in FIG. 1 of a device and computer 30 having the application 40. The application 40 is stored on the computer 30 and can access data and additional programs at the back end of the application, for example, in the program(s) 74 stored in the control system 70.

The program(s) 74 can include, all or in part, a series of executable steps for implementing the method of the present disclosure. A program, incorporating the present method, can be all or in part stored in the computer readable storage medium on the control system or, in all or in part, on a computer 30 or device. It is envisioned that the control system 70 can not only store the profile of users, but in one embodiment, can interact with a website for viewing on a display of a device such as a mobile device, or in another example the Internet, and receive user input related to the method and system of the present disclosure. It is understood that FIG. 1 depicts one or more profiles 83, however, the method can include multiple profiles, users, registrations, etc. It is envisioned that a plurality of users or a group of users can register and provide profiles using the control system for use according to the method and system of the present disclosure.

### Still Further Embodiments and Examples

It is understood that the features shown in some of the FIGS., for example block diagrams, are functional representations of features of the present disclosure. Such features are shown in embodiments of the systems and methods of the present disclosure for illustrative purposes to clarify the functionality of features of the present disclosure.

The methods and systems of the present disclosure can include a series of operation blocks for implementing one or more embodiments according to the present disclosure. In some examples, operational blocks of one or more FIGS. may be similar to operational blocks another FIG. A method shown in one FIG. may be another example embodiment which can include aspects/operations shown in another FIG. and discussed previously.

### Additional Embodiments and Examples

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user's option to cancel such profile or account, and/or input of data, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner. A user interface can also allow a user or an individual to remove all their historical data.

### Other Additional Embodiments and Examples

In one example, Artificial Intelligence (AI) can be used, all or in part, for a learning model for analyzing data associated with items and assets.

In another example, the control system 70 can be all or part of an Artificial Intelligence (AI) system. For example, the control system can be one or more components of an AI system.

It is also understood that the method 100 according to an embodiment of the present disclosure, can be incorporated into (Artificial Intelligence) AI devices, which can communicate with respective AI systems, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

It is understood that as discussed herein, a download or downloadable data can be initiated using a voice command or using a mouse, touch screen, etc. In such examples a mobile device can be user initiated, or an AI device can be used with consent and permission of users. Other examples of AI devices include devices which include a microphone, speaker, and can access a cellular network or mobile network, a communications network, or the Internet, for example, a vehicle having a computer and having cellular or satellite communications, or in another example, IoT (Internet of Things) devices, such as appliances, having cellular network or Internet access.

### Further Discussion Regarding Examples and Embodiments

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Further Additional Examples and Embodiments

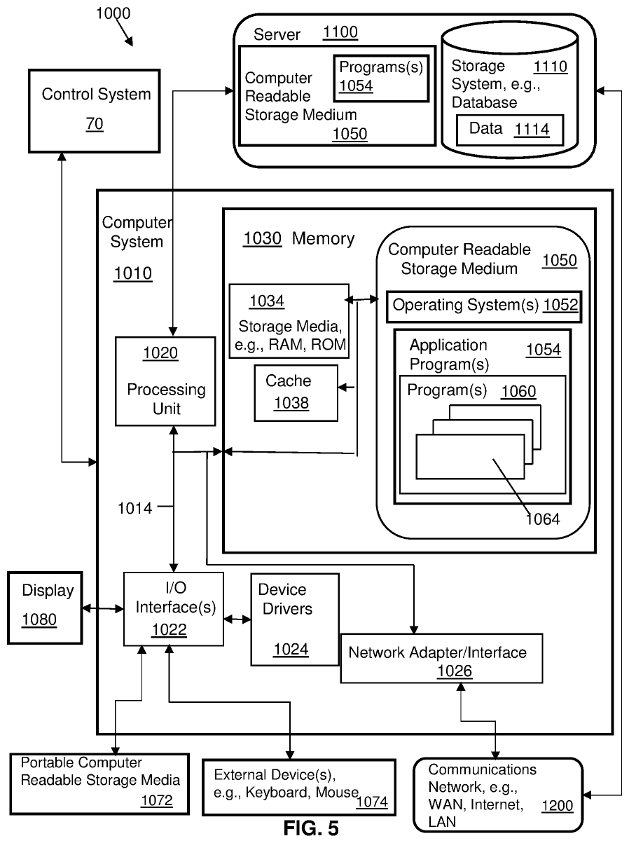

Referring to FIG. 5, an embodiment of system or computer environment 1000, according to the present disclosure, includes a computer system 1010 shown in the form of a generic computing device. The method 100, for example, may be embodied in a program 1060, including program instructions, embodied on a computer readable storage device, or a computer readable storage medium, for example, generally referred to as computer memory 1030 and more specifically, computer readable storage medium 1050. Such memory and/or computer readable storage media includes non-volatile memory or non-volatile storage, also known and referred to non-transient computer readable storage media, or non-transitory computer readable storage media. For example, such non-volatile memory can also be disk storage devices, including one or more hard drives. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, the system or computer environment 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that a control system 70, communicating with a computer system, can include all or part of the computer system 1010 and its components, and/or the control system can communicate with all or part of the computer system 1010 and its components as a remote computer system, to achieve the control system functions described in the present disclosure. The control system function, for example, can include storing, processing, and executing software instructions to perform the functions of the present disclosure. It is also understood that the one or more computers or computer systems shown in FIG. 1 similarly can include all or part of the computer system 1010 and its components, and/or the one or more computers can communicate with all or part of the computer system 1010 and its components as a remote computer system, to achieve the computer functions described in the present disclosure.

In an embodiment according to the present disclosure, one or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions. For example, in one embedment according to the present disclosure, a program embodying a method is embodied in, or encoded in, a computer readable storage medium, which includes and is defined as, a non-transient or non-transitory computer readable storage medium. Thus, embodiments or examples according to the present disclosure, of a computer readable storage medium do not include a signal, and embodiments can include one or more non-transient or non-transitory computer readable storage mediums. Thereby, in one example, a program can be recorded on a computer readable storage medium and become structurally and functionally interrelated to the medium.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

### Still Further Additional Examples and Embodiments

Referring to FIG. 6, an example system 1500 for use with the embodiments of the present disclosure is depicted. The system 1500 includes a plurality of components and elements connected via a system bus 1504 (also referred to as a bus). At least one processor (CPU) 1510, is connected to other components via the system bus 1504. A cache 1570, a Read Only Memory (ROM) 1512, a Random Access Memory (RAM) 1514, an input/output (I/O) adapter 1520, a sound adapter 1530, a network adapter 1540, a user interface adapter 1552, a display adapter 1560 and a display device 1562, are also operatively coupled to the system bus 1504 of the system 1500.

One or more storage devices 1522 are operatively coupled to the system bus 1504 by the I/O adapter 1520. The storage device 1522, for example, can be any of a disk storage device (e.g., a magnetic or optical disk storage device), a solid state magnetic device, and so forth. The storage device 1522 can be the same type of storage device or different types of storage devices. The storage device can include, for example, but not limited to, a hard drive or flash memory and be used to store one or more programs 1524 or applications 1526. The programs and applications are shown as generic components and are executable using the processor 1510. The program 1524 and/or application 1526 can include all of, or part of, programs or applications discussed in the present disclosure, as well vice versa, that is, the program 1524 and the application 1526 can be part of other applications or program discussed in the present disclosure. The storage device can communicate with the control system 70 which has various functions as described in the present disclosure.

A speaker 1532 is operatively coupled to system bus 1504 by the sound adapter 1530. A transceiver 1542 is operatively coupled to system bus 1504 by the network adapter 1540. A display 1562 is operatively coupled to the system bus 1504 by the display adapter 1560.

One or more user input devices 1550 are operatively coupled to the system bus 1504 by the user interface adapter 1552. The user input devices 1550 can be, for example, any of a keyboard, a mouse, a keypad, an image capture device, a motion sensing device, a microphone, a device incorporating the functionality of at least two of the preceding devices, and so forth. Other types of input devices can also be used, while maintaining the spirit of the present invention. The user input devices 1550 can be the same type of user input device or different types of user input devices. The user input devices 1550 are used to input and output information to and from the system 1500.

### Other Aspects and Examples

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Additional Aspects and Examples

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

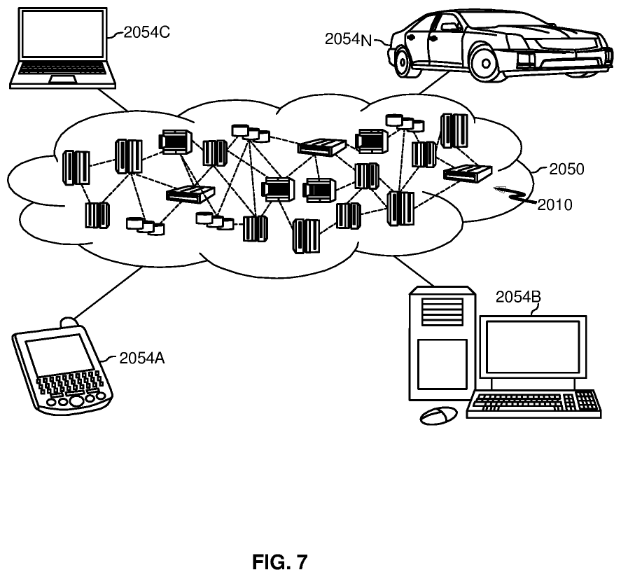

Referring now to FIG. 7, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 7 are intended to be illustrative only and that computing nodes 2010 and cloud computing environment 2050 can communicate with any type of computerized device over any type of network and/or network addressable connection (e.g., using a web browser).

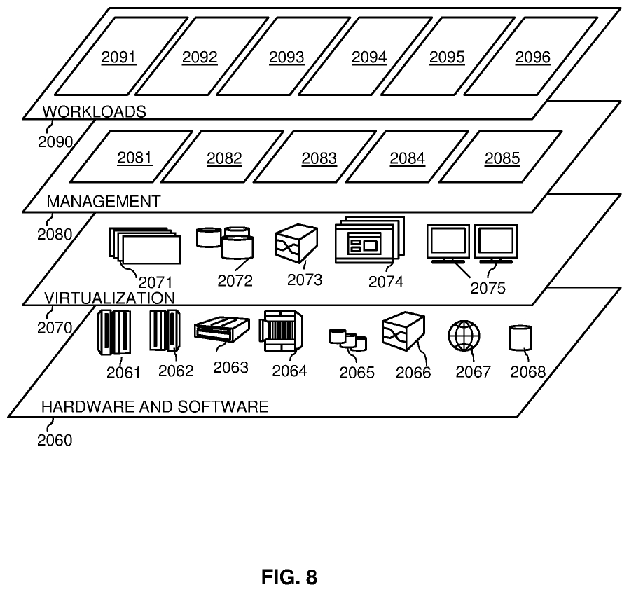

Referring now to FIG. 8, a set of functional abstraction layers provided by cloud computing environment 2050 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and identifying and communicating package delivery risks using a computer 2096.

1. A computer-implemented method for identifying and communicating package delivery risks to reduce package damage risk during delivery, comprising:
receiving, at a computer, package delivery data for a package to be delivered;
determining, using the computer, package delivery factors, the factors including package fragility;
analyzing, using the computer, product information and product reviews based on the factors, the analyzing including using natural language processing to evaluate the product information and product reviews to identify language related to the factors;
generating a real-time fragility score which includes analyzing the package delivery data and analyzing external environmental data;
determining a probability of risk of damage to the package based on the factors and the analysis of the product information and the product reviews, and the real-time fragility score;
weighting the factors in response to the determining the probability of risk of damage to the package;
calculating a package risk score based on the weighting of the factors and the determining of the probability of risk of damage;
generating a best delivery practice for the package based on the package risk score; and
communicating the package risk score and best delivery practice to a device.

2. The method of claim 1, wherein the package delivery factors include sensitivity of the package to a collision.

3. The method of claim 1, wherein the package delivery factors include sensitivity to a stacking weight.

4. The method of claim 1, wherein the factors include package content sensitivity.

5. The method of claim 4, wherein the package content sensitivity includes determining factors for environmental conditions.

6. The method of claim 5, wherein the environment conditions include heat and cold.

7. The method of claim 1, wherein the package is delivered by a delivery truck and delivery person.

8. The method of claim 1, wherein the package is delivered by a drone operated by a drone operator or a drone control system.

9. The method of claim 1, wherein the device is selected from a group consisting of: a delivery person's device, a device of a drone operator, and a drone control system device.

10. A system using a computer for identifying and communicating package delivery risks to reduce package damage risk during delivery, which comprises:
a computer system comprising; a computer processor, a computer-readable storage medium, and program instructions stored on the computer-readable storage medium being executable by the processor, to cause the computer system to perform the following functions to;
receive, at a computer, package delivery data for a package to be delivered;
determine, using the computer, package delivery factors, the factors including package fragility;
analyze, using the computer, product information and product reviews based on the factors, the analyzing including using natural language processing to evaluate the product information and product reviews to identify language related to the factors;
generate a real-time fragility score which includes analyzing the package delivery data and analyzing external environmental data;
determine a probability of risk of damage to the package based on the factors and the analysis of the product information and the product reviews, and the real-time fragility score;
weight the factors in response to the determining the probability of risk of damage to the package;
calculate a package risk score based on the weighting of the factors and the determining of the probability of risk of damage;
generate a best delivery practice for the package based on the package risk score; and
communicate the package risk score and best delivery practice to a device.

11. The system of claim 10, wherein the package delivery factors include sensitivity of the package to a collision.

12. The system of claim 10, wherein the package delivery factors includes sensitivity to a stacking weight.

13. The system of claim 10, wherein the factors include package content sensitivity.

14. The system of claim 13, wherein the package content sensitivity includes determining factors for environmental conditions.

15. The system of claim 14, wherein the environment conditions include heat and cold.

16. The system of claim 10, wherein the package is delivered by a delivery truck and delivery person.

17. The system of claim 10, wherein the package is delivered by a drone operated by a drone operator or a drone control system.

18. The system of claim 10, wherein the device is selected from a group consisting of: a delivery person's device, a device of a drone operator, and a drone control system device.

19. A computer program product for identifying and communicating package delivery risks to reduce package damage risk during delivery, the computer program product comprising a computer readable storage medium having program instructions embodied therewith, the program instructions executable by a computer to cause the computer to perform functions, by the computer, comprising the functions to:
receive, at a computer, package delivery data for a package to be delivered;
determine, using the computer, package delivery factors, the factors including package fragility;
analyze, using the computer, product information and product reviews based on the factors, the analyzing including using natural language processing to evaluate the product information and product reviews to identify language related to the factors;
generate a real-time fragility score which includes analyzing the package delivery data and analyzing external environmental data;
determine a probability of risk of damage to the package based on the factors and the analysis of the product information and the product reviews, and the real-time fragility score;
weight the factors in response to the determining the probability of risk of damage to the package;
calculate a package risk score based on the weighting of the factors and the determining of the probability of risk of damage;
generate a best delivery practice for the package based on the package risk score; and
communicate the package risk score and best delivery practice to a device.

20. The computer program product of claim 19, wherein the package delivery factors include sensitivity of the package to a collision.
